(19) United States
(12) Patent Application Publication
(10) Pub. No.: US 2009/0032993 A1
(43) Pub. Date: Feb. 5, 2009

(54) SOLUTION CASTING METHOD AND DEPOSIT REMOVING DEVICE

(75) Inventor: Kazumasa Yokoyama, Kanagawa (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/282,409

(22) PCT Filed: Mar. 7, 2007
(86) PCT No.: PCT/JP2007/055019

§ 371 Date: Sep. 10, 2008

(30) Foreign Application Priority Data
Mar. 10, 2006 (JP) 2006-065726

(51) Int. Cl. B29D 7/00; B29C 39/16

(52) U.S. Cl. 264/212; 425/225

(57) ABSTRACT

A drum cleaning device (65) has a nozzle (66). The drum cleaning device (65) is disposed in the upstream from a peel roller (34). A dope (21) is cast onto a surface of the casting drum(32) by using a casting die (30). The casting drum(32) is rotated to form a casting film(33) on the surface. The casting film(33) is cooled by the casting drum(32). Deposits containing fatty acid ester as a main component are precipitated from the casting film(33) onto the surface. The peel roller (34) peels off the casting film(33) as a wet film(38). The drum cleaning device (65) blasts gas mixture containing air and dry ice particles from the nozzle (66) onto the surface.

### TECHNICAL FIELD

The present invention relates to a solution casting method and a deposit removing device.

### BACKGROUND ART

A polymer film, hereinafter referred to as a film, is widely used as an optical functional film due to excellent optical transparency, softness, and lightweight. In particular, by virtue of strength and low birefringence index, a cellulose ester based film formed of cellulose acylate and the like is used as a photosensitive film and an optical functional film such as a protective film for a polarizing filter and an optical compensation film used for an LCD whose market is recently expanding.

A melt-extrusion method and a solution casting method are major film production methods. In the melt-extrusion method, a polymer is heated and melted, and then extruded by an extruding device to produce the film. The melt-extrusion method has advantages such as high productivity and comparatively low production facility cost. However, in the melt-extrusion method, it is difficult to produce a high quality film used for the optical functional film, since adjustment of the film thickness is difficult, and fine streaks (die lines) are often formed on the film. On the other hand, in the solution casting method, a polymer solution (a dope) containing a polymer and a solvent is cast onto a support to form a casting film. The casting film is peeled off from the support after the casting film obtains a self supporting property. The peeled casting film is referred to as a wet film. The wet film is dried to obtain a film. In comparison with the melt extrusion method, the film produced by the solution casting method is superior in optical anisotropy and thickness uniformity, and contains a lesser amount of extraneous matters. Therefore, the optical functional films used for the LCDs and the like are mostly produced by the solution casting method.

In the solution casting method, a polymer solution (hereinafter referred to a dope) is prepared by dissolving a polymer such as cellulose triacetate in a solvent mixture containing dichloromethane, methyl acetate, or the like as a main solvent. An additive is mixed into the dope to prepare a casting dope. The casting dope is cast from a casting die onto a support such as a casting drum, an endless belt, or the like to form the casting film, which is hereinafter referred as a casting process. The casting dope between the casting die and the support is referred to as a casting bead. The casting film is dried and cooled on the support to obtain the self supporting property. Thereafter, the casting film is peeled off from the support as a wet film. The wet film is dried to obtain the film. The film is wound up into a roll.

In the casting process, substances containing fatty acid, fatty acid ester, fatty acid metal salt or the like as a main component are precipitated out of the casting film and adhere to the support surface. When such support is used for the film production, the precipitates are transferred to the film surface, which makes optical properties non-uniform across the film. For this reason, it has been necessary to periodically clean the support surface during the production of the film in the solution casting method.

Cleaning methods of the support surface are disclosed in the following. In a method disclosed in Japanese Patent Laid-Open Publication No. 2003-001654, a support surface is continuously wiped by a non-woven cloth in which an organic solvent or the like is absorbed, that is, a wet treatment. In a method disclosed in Japanese Patent Laid-Open Publication No. 2001-089590, the extraneous matters on the film surface are removed by subjecting the film surface to a solvent treatment, a corona discharge treatment, a plasma discharge treatment, a flame treatment, or the like.

However, when the support surface is cleaned by the wet treatment such as disclosed in Japanese Patent Laid-Open Publication No. 2003-001654, the organic solvent often remains on the support surface after the cleaning. If the casting film is formed on such support surface, the remaining organic solvent causes streaks and asperities on the surface of the casting film, which results in a secondary failure. Moreover, solid extraneous matters may get caught between the non-woven cloth and the support during the cleaning and damage the support surface, which may also result in the secondary failure. When the dope is cast onto the damaged support surface, the damages are transferred onto the film, causing the unevenness in the optical properties of the film.

When the extraneous matters on the film surface are removed by the method such as disclosed in the Japanese Patent Laid-Open Publication No. 2001-089590, it is preferable that the extraneous matters are removed under conditions not affecting the film properties. However, it is difficult to find out such conditions. Since the conditions differ according to the material of the film and the composition thereof, it is difficult to apply the predetermined conditions to a film production apparatus capable of producing various types of films.

Recently, higher film production speed (for instance, 50 m/min or above) in the solution casting method is desired due to rapidly increasing demands for thin-type display devices such as an LCD (Liquid Crystal Display). However, in the high-speed film production, cleaning powers of the above cleaning methods are not sufficient. Therefore, it is necessary to slow down the casting speed to clean the surface of the support, or to suspend the casting process to replace the support.

Since a dope used in the solution casting method often contains a flammable compound, anti-explosion measures are taken, for instance, atmosphere in a casting chamber is substituted by nitrogen. In other words, at the time of cleaning the surface of the support, or replacing the support, it is necessary to substitute air for the atmosphere of the casting chamber. After the cleaning or the replacement, it is necessary to substitute nitrogen for the atmosphere (air). The above requirements which are specific to the solution casting method made speedup of the solution casting extremely difficult.

A main object of the present invention is to provide a solution casting method and a deposit removing device in a solution casting apparatus capable of removing deposits on the support surface without damaging the support surface.

Another object of the present invention is to provide the solution casting method and the deposit removing device in the solution casting apparatus suitable for a mass production.

### DISCLOSURE OF INVENTION

To accomplish the above objects and other objects, a solution casting method according to the present invention include following steps: casting a dope containing a polymer and a solvent onto a surface of a moving endless support to form a casting film on the surface; peeling the casting film from the surface and drying the peeled casting film to form a film; and blasting a cleaning gas containing particles onto the surface after the casting film is peeled off and before next casting film is formed.

It is preferable that the particles are dry ice particles. It is preferable that the average particle diameter of the dry ice is not less than 5 μm and not more than 20 μm. It is preferable to blast the cleaning gas onto the surface for a time not less than 0.001 second and not more than 5 seconds. It is preferable that a blast angle between the surface and a blast direction of the cleaning gas is not less than 45° and not more than 135°.

It is preferable to blast the cleaning gas through a nozzle, and a carrier gas and liquid carbon dioxide are supplied to the nozzle, and the cleaning gas containing dry ice particles is generated by feeding the liquid carbon dioxide into a channel of the carrier gas inside the nozzle.

It is preferable to satisfy one of the following mathematical expressions when Q1 (m³/mm·min) is a volume flow rate of the carrier gas, and Q2 (kg/mm·min) is a mass flow rate of the carbon dioxide:

0.0025≦Q2≦0.025 (kg/mm·min) on condition that 0.0075<Q1<0.025 (m³/mm·min) (1)

0.0016≦Q2≦0.034 (kg/mm·min) on condition that 0.025≦Q1<0.05 (m³/mm·min) (2)

0.00083≦Q2≦0.042 (kg/mm·min) on condition that 0.05≦Q1<0.1 (m³/mm·min) (3)

It is preferable the nozzle further includes a carrier gas inlet for introducing the carrier gas, a carbon dioxide inlet for introducing the liquid carbon dioxide a cleaning gas orifice for blasting the cleaning gas, a carrier gas channel for connecting the carrier gas inlet and the cleaning gas orifice, a carbon dioxide channel for connecting the carbon dioxide inlet and the carrier gas channel, and a particle generation section provided in the carrier gas channel. The particle generation section includes an outlet of the carbon dioxide channel, and generates the dry ice particles by feeding the liquid carbon dioxide to the carrier gas channel.

It is preferable that an outlet of the carbon dioxide channel is provided with an orifice. It is preferable that a rectifying pocket having a larger cross section than the carrier gas channel is provided in the carrier gas channel for rectifying the carrier gas.

It is preferable that a distance between the cleaning gas orifice and the surface is not less than 0.1 mm and not more than 15 mm. It is preferable that a blast pressure of the cleaning gas is not less than 600 kPa and not more than 4000 kPa.

It is preferable that the support is a casting drum. The deposits on the surface contain at least one of fatty acid, fatty acid ester, and fatty acid metal salt. It is preferable that the polymer contains cellulose acylate, and the cellulose acylate is preferably one of cellulose triacetate, cellulose acetate, propionate, and cellulose acetate butyrate.

A deposit removing device for removing deposits from a surface of a moving endless support of a solution casting apparatus which casts a dope containing a polymer and a solvent onto the surface to form a casting film, peels the casting film from the surface and dries the peeled casting film to form a film includes a nozzle for blasting a cleaning gas containing particles on the surface. The nozzle is provided close to an area of the surface between a position from which the casting film is peeled and a position onto which the dope is cast to form a next casting film.

It is preferable that the particles contain dry ice. It is preferable that an average particle diameter of the dry ice is not less than 5 μm and not more than 20 μm. It is preferable that the cleaning gas is blasted onto the surface for a time not less than 0.001 second and not more than 5 seconds. It is preferable that a blast angle between a blast direction of the cleaning gas and the surface is not less than 45° and not more than 135°.

It is preferable that a carrier gas and liquid carbon dioxide are supplied to the nozzle, and the cleaning gas containing dry ice particles is generated by feeding the liquid carbon dioxide into a channel of the carrier gas inside the nozzle.

It is preferable to satisfy one of the following mathematical expressions when Q1 (m³/mm·min) is a volume flow of the carrier gas, and Q2 (kg/mm·min) is a mass flow of the carbon dioxide:

0.0025≦Q2≦0.025 (kg/mm·min) on condition that 0.0075<Q1<0.025 (m³/mm·min) (4)

0.0016≦Q2≦0.034 (kg/mm·min) on condition that 0.025≦Q1<0.05 (m³/mm·min) (5)

0.00083≦Q2≦0.042 (kg/mm·min) on condition that 0.05≦Q1<0.1 (m³/mm·min) (6)

It is preferable that the nozzle further includes a carrier gas inlet for introducing the carrier gas, a carbon dioxide inlet for introducing the liquid carbon dioxide, a cleaning gas orifice for blasting the cleaning gas, a carrier gas channel for connecting the carrier gas inlet and the cleaning gas orifice, a carbon dioxide channel for connecting the carbon dioxide inlet and the carrier gas channel, and a particle generation section provided in the carrier gas channel and including an outlet of the carbon dioxide channel. The particle generation section generates the dry ice particles by feeding the liquid carbon dioxide to the carrier gas channel.

It is preferable that an outlet of the carbon dioxide channel is provided with an orifice. It is preferable that a rectifying pocket having a larger cross section than the carrier gas channel is provided in the carrier gas channel for rectifying the carrier gas.

It is preferable that a distance between the cleaning gas orifice and the surface is not less than 0.1 mm and not more than 15 mm. It is preferable that a blast pressure of the cleaning gas is not less than 600 kPa and not more than 4000 kPa.

It is preferable that the deposit removing device includes a plurality of the nozzles disposed in a width direction of the support.

It is preferable that the support is a casting drum. The deposits contain at least one of fatty acid, fatty acid ester, and fatty acid metal salt. It is preferable that a polymer contains cellulose acylate, and the cellulose acylate is preferably one of cellulose triacetate, cellulose acetate, propionate, and cellulose acetate butyrate.

According to the solution casting method of the present invention, since the cleaning gas containing the particles is blasted on the surface after the casting film is peeled off and before the next casting film is formed, the surface is cleaned without being damaged. Further, since the surface is cleaned by the dry method by which the cleaning gas is blasted, there are no traces of cleaning solvent on the surface caused by, for instance, the wet method. Therefore, the present invention prevents secondary failures caused by transfer of the trances of the cleaning solvent. In addition, the present invention enables to clean the surface without reducing the dope casting speed. As a result, the film productivity enhances.

Since the particles contain the dry ice, the deposits on the surface are removed, preventing damages on the surface.

Since the blast pressure of the cleaning gas is not more than 600 kPa and not less than 4000 kPa, and more preferably not less than 1000 kPa and not more than 2500 kPa, the deposits on the surface are removed by the collision with the dry ice. By this collision, the dry ice is melted on the surface of the support, and the deposits are dissolved into the melted carbon dioxide. The deposits and the carbon dioxide are vaporized together. In this way, it is also possible to remove the deposits from the surface of the support. Since the average particle diameter of the dry ice is not less than 5 μm and not more than 20 μm, the carbon dioxide in each state (solid/liquid/gas) effectively removes the deposits in accordance with the amount and the composition of the deposits.

Since the blast angle between the blast direction of the cleaning gas and the surface is not less than 45° and not more than 135°, and more preferably not less than 85° and not more than 95°, the deposits on the surface are effectively removed. Further, since the distance between the cleaning gas orifice and the surface is not less than 0.1 mm and not more than 15 mm, and more preferably not more than 0.1 mm and 2 mm, the deposits on the surface are removed without damaging the surface. Further, since the blast time of the cleaning gas required for removing the deposits is preferably not less than 0.001 second and not more than 5 seconds, and more preferably not less than 0.01 second and not more than 5 seconds, the deposits on the surface are removed during operation of the film production line. As a result, the productivity of the film production is enhanced.

### BRIEF DESCRIPTION OF DRAWINGS

FIG. 1 is an explanatory view of a film production line of a solution casting method according to a first embodiment of the present invention;

FIG. 2 is a side view of a drum cleaning device and each section in the proximity thereof according to the first embodiment;

FIG. 3 is a section view of a film production line according to a second embodiment;

FIG. 4 is a side view of a drum cleaning device and each section in the proximity thereof according to a third embodiment;

FIG. 5 is a front view of a drum cleaning device according to a third embodiment viewed from an upstream to a downstream with respect to a moving direction of its surface;

FIG. 6 is a front view of a drum cleaning device according to a fourth embodiment viewed from an upstream to a downstream with respect to a moving direction of its surface;

FIG. 7 is a plan view of a fourth embodiment of a drum cleaning device viewed from a surface thereof;

FIG. 8 is a graph showing flow rates Q2 of liquid carbon dioxide and Q1 of a carrier gas sent to the drum cleaning device of the second embodiment, and results of CT1 when a cleaning gas which contains the liquid carbon dioxide and the carrier gas is blasted onto a surface of the casting drum; and

FIG. 9 is a graph showing the flow rates Q1 and Q2, and the results of CT1 when the cleaning gas is blasted onto the surface of the casting drum.

### BEST MODE FOR CARRYING OUT THE INVENTION

Hereinafter the embodiments of the present invention are described in detail. However, the embodiments do not limit the scope of the present invention.

[Solution Casting Method]

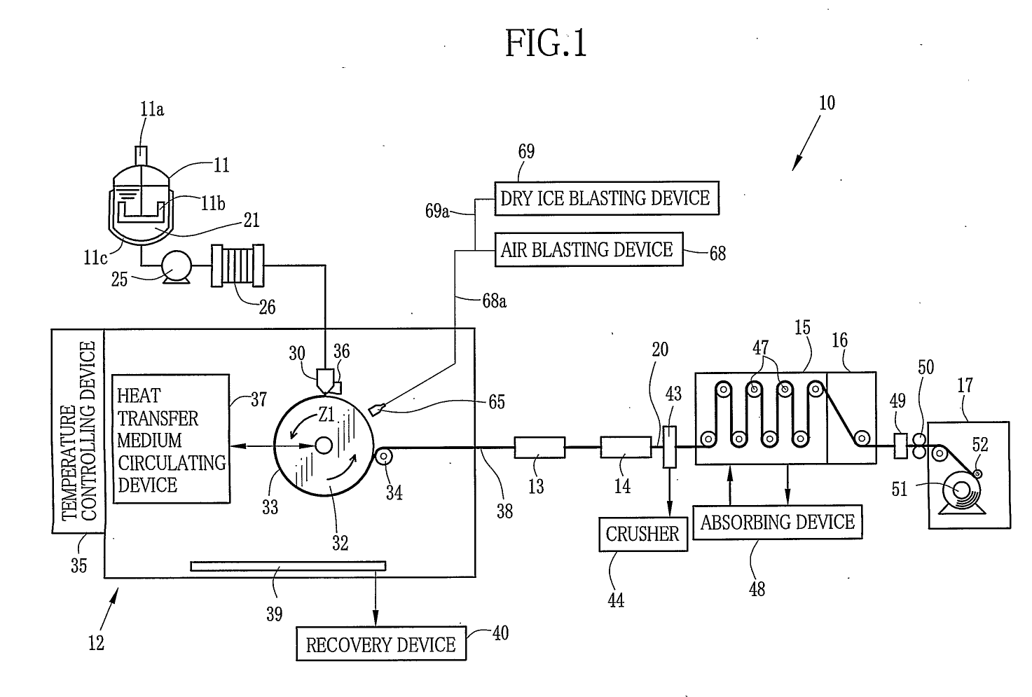

In FIG. 1, a film production line 10 has a stock tank 11, a casting chamber 12, a pin tenter 13, a clip tenter 14, a drying chamber 15, a cooling chamber 16, and a winding chamber 17.

The stock tank 11 is provided with a stirring blade 11b rotated by a motor 11a, and a jacket 11c. In the stock tank 11, a dope 21 which is a material for a film 20 is stored. A temperature of the dope 21 is kept approximately constant by the jacket 11c covering the outer periphery of the stock tank 11. The dope 21 is stirred by the stirring blade 11b to be kept uniform and to prevent coagulation of a polymer. In the downstream from the stock tank 11, a pump 25 and a filtration device 26 are provided. A preparing method of the dope 21 will be described in detail later.

The casting chamber 12 is provided with a casting die 30 having an opening from which the dope 21 flows out, a casting drum 32 which is a support, a peel roller 34 which peels off a casting film 33 from the casting drum 32, and a temperature controlling device 35 which controls an internal temperature of the casting chamber 12. A decompression chamber 36 is disposed close to a surface 32b of the casting drum 32 between the casting die 30 and the peel roller 34.

The dope 21 is cast from the casting die 30 onto the casting drum 32 disposed below the casting die 30. The casting die 30 is formed of a material having high thermal expansion rate and high corrosion resistance against a liquid mixture containing an electrolyte aqueous solution, dichloromethane, methanol, or the like.

It is preferable that the finish precision of a contacting surface of the casting die 30 to the dope is 1 μm/m or less of the surface roughness, and the straightness is 1 μm/m or less in any direction. Thus, the casting die 30 forms the uniform casting film 33 without streaks and unevenness on the casting drum 32.

The casting drum 32 has a cylindrical or a tubular shape, and is rotated around a shaft 32a by a driving device (not shown). The surface 32b of the casting drum 32 is chromium plated to obtain sufficient corrosion resistance and strength. A heat transfer medium circulation device 37 is attached to the casting drum 32. The heat transfer medium kept at a desired temperature by the heat transfer medium circulation device 37 passes through a heat transfer medium passage inside the casting drum 32, and thus the temperature of the surface 32b is kept at the desired temperature.

A width of the casting drum 32 is not particularly limited. However, it is preferable that the width of the casting drum 32 is in a range between 1.1 times and 2.0 times larger than a casting width of the dope. It is preferable that the polishing is made such that a surface roughness of the surface 32b is at most 0.01 μm. Surface defects must be prevented as much as possible. To be specific, the number of pin holes whose diameter is at least 30 μm is preferably zero. The number of pinholes whose diameter is not less than 10 μm and less than 30 μm is preferably 1 or less per 1 m². The number of pinholes whose diameter is less than 10 μm is 2 or less per 1 m². The positional fluctuations in vertical directions of the surface 32b associated with the rotation of the casting drum 32 are preferably adjusted to be 200 μm or less. The velocity fluctuations of the casting drum 32 are 3% or less. The film meandering in widthwise direction per one rotation of the casting drum 32 is regulated to be 3 mm or less.

The material of the casting drum 32 is preferably a stainless steel, and more preferably SUS 316 which offers sufficient corrosion resistance and strength. The chromium plating applied to the surface 32b of the casting drum 32 is preferably a hard chromium plating, with Vickers hardness (Hv) of 700 or more, and the plating thickness of 2 μm or more.

The dope 21 is cast from the casting die 30 onto the surface 32b of the casting drum 32. In the casting process, the casting bead is formed between the casting die 30 and the casting drum 32, and the casting film 33 is formed on the surface 32b of the casting drum 32. The decompression chamber 36 decompresses an area upstream from the casting bead with respect to a moving direction of the casting drum 32, that is, an area upstream from a surface of the casting bead which will come in contact with the surface 32b of the casting drum 32, with a desired pressure so as to stabilize the casting bead and improve adhesion between the casting film 33 and the surface 32b during the high-speed rotation of the casting drum 32. After the casting film 33 obtains the self supporting property, the peel roller 34 peels off the casting film 33 on the casting drum 32 as a wet film 38.

The casting chamber 12 has a condenser 39 for condensing organic solvent vapor, and a recovery device 40 for recovering the condensed solvent. The organic solvent condensed in the condenser 39 is recovered by the recovery device 40. The recovered solvent is refined in a refining device (not shown), and reused as the solvent for preparing the dope.

In the downstream from the casting chamber 12, the pin tenter 13 which dries the wet film 38 peeled off by the peel roller 34 to obtain the film 20, and the clip tenter 14 which stretches the film 20 while drying are provided. The pin tenter 13 is a drying device having a plurality of pins for fixing the wet film 38. The clip tenter 14 is a drying device having clips to hold the film 20. Desired optical properties are imparted to the film 20 by a stretch process in the clip tenter 14 under predetermined conditions. It is also possible to impart the optical properties to the film 20 after the film 20 is wound up. In this case, it is possible to omit the clip tenter 14.

An edge slitting device 43 is provided in the downstream from the clip tenter 14. The edge slitting device 43 is provided with a crusher 44. Both side edges of the film 20 are cut off by the edge slitting device 43, and transported to the crusher 44 and crushed for reusing.

In the drying chamber 15, a plurality of rollers 47, and an absorbing device 48 for absorbing and recovering the solvent vapor are provided. A compulsory neutralization device (a neutralization bar) 49 is provided in the downstream from the cooling chamber 16 attached to the drying chamber 15. In this embodiment, a knurling roller pair 50 is provided in the downstream from the compulsory neutralization device 49. Inside the winding chamber 17, a winding roller 51 and a press roller 52 are provided.

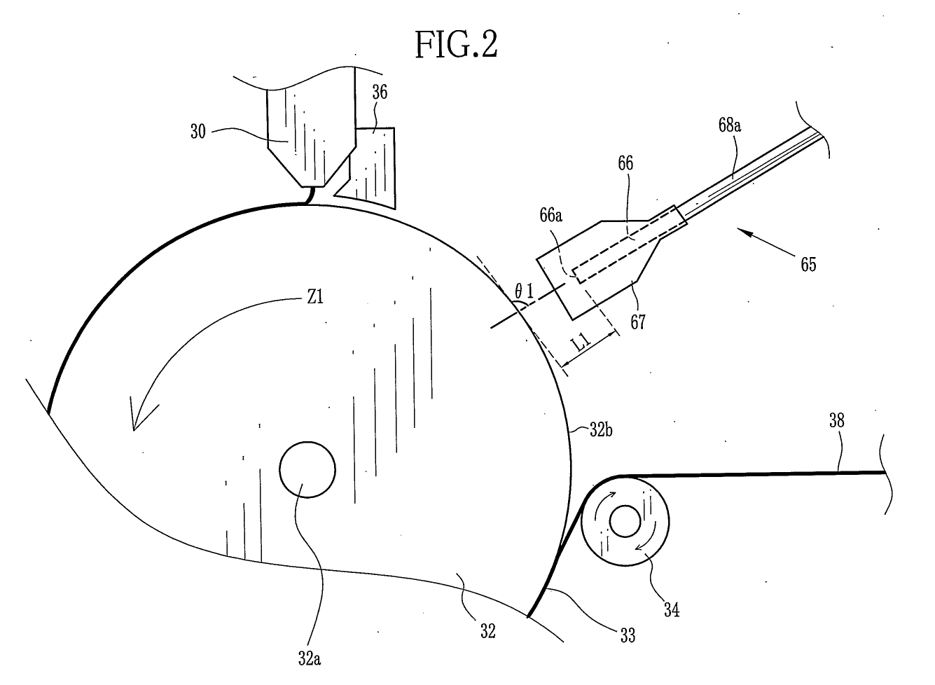

As shown in FIG. 2, a drum cleaning device 65 is disposed close to the surface area of the casting drum 32 between the decompression chamber 36 and the peel roller 34. The drum cleaning device 65 is provided with a nozzle 66 for blasting a gas containing dry ice particles (hereinafter referred to as a gas mixture, or a so-called cleaning gas), and a cover 67 provided around the outer periphery of the nozzle 66. Through a pipe 68a, the nozzle 66 is connected to an air blasting device 68. A pipe 69a connects a dry ice blasting device 69 to the pipe 68a.

The air blasting device 68 has a blast pressure controlling device (not shown) capable of controlling the blast pressure. By operating the blast pressure controlling device, the air at the desired pressure is blasted from a blast orifice 66a at a tip of the nozzle 66 through the pipe 68a. The air blasting device 68 is provided with a timer. The air blasting device 68 blasts air onto the surface 32b of the casting drum 32 for a time set by the timer.

The blast pressure controlling device can be constituted of, for instance, a compressed air cylinder and a temperature controller for controlling the temperature of the compressed air in the cylinder.

The dry ice blasting device 69 generates the dry ice particles of a desired particle diameter, and blasts the dry ice particles to the pipe 69a. The dry ice particles are sent to the pipe 68a. In the pipe 68a, the dry ice particles are mixed with the air blasted from the air blasting device 68, which is referred to as a gas mixture. The gas mixture is blasted from the blast orifice 66a of the nozzle 66 through the pipe 68a.

A shifting section (not shown) is connected to the drum cleaning device 65. The shifting section enables to move the nozzle 66 of the drum cleaning device 65 to a desired direction. By operating the shifting section, a blast distance L1 between the blast orifice 66a and the casting drum 32, a blast angle θ1 between a blast direction of the gas mixture and the surface 32b of the casting drum 32, and the like are set at desired values.

Next, an example of a production method of the film 20 by the film production line 10 is described with referring to FIG. 1. In the stock tank 11, the temperature of the dope 21 is kept in a range of 25° C. to 35° C. by supplying the heat transfer medium inside the jacket 11c. The dope 21 is stirred by the stirring blade 11b to be kept uniform. The dope 21 is sent from the stock tank 11 to the filtration device 26 through the pump 25, and then filtered through the filtration device 26 to remove impurities from the dope 21. The dope 21 is cast from the casting die 30 as the casting bead onto the surface 32b of the casting drum 32 cooled at a predetermined temperature. It is preferable that the temperature of the dope 21 at the casting is kept approximately constant in a range of 30° C. to 35° C.

The driving device rotates the casting drum 32 around the shaft 32a. The casting drum 32 is rotated in a moving direction Z1 at a velocity not less than 30 m/min and not more than 200 m/min. The temperature of the surface 32b of the casting drum 32 is adjusted in a predetermined range. The surface temperature of the casting drum 32 is adjusted to be in an approximately constant range, preferably from −10° C. to 10° C. The casting film 33 is cooled and solidified (gelated) by the cooled casting drum 32 to obtain the self supporting property. The heat transfer medium circulation device 37 controls and constantly keeps the temperature of the surface 32b at the desired value. As the casting film 33 is cooled, cross-linking points are formed so that gelation in the casting film 33 is advanced.

With the advance of the gelation, the casting film obtains the self supporting property. Thereafter, the peel roller 34 peels off the casting film 33 from the casting drum 32. The peeled casting film 33 is hereinafter referred to the wet film 38. The wet film 38 is sent to the pin tenter 13.

Internal temperature of the casting chamber 12 is adjusted to be approximately constant by the temperature controlling device 35. The internal temperature of the casting chamber 12 is preferably kept approximately constant in a range of 10° C. to 57° C. Inside the casting chamber 12, solvent vapor is generated from the dope 21 and the casting film 33. In this embodiment, the solvent vapor is condensed by the condenser 39 and recovered by the recovery device 40. Then the recovered solvent vapor is refined by the refining device and reused as the solvent used for the dope preparation.

In the pin tenter 13, the plurality of pins are pierced through the both side edges of the wet film 38 to fix the wet film 38. Thereafter, the wet film 38 is dried while being transported through the pin tenter 13. The dried film released from the pin tenter 13 is hereinafter referred to as the film 20. The film 20 still contains the solvent therein. The film 20 is then sent to the clip tenter 14. It is preferable that the remaining solvent amount in the film 20 just before entering the clip tenter 14 is 50 wt % to 150 wt. %. In the present invention, the remaining solvent amount refers to an amount of the remaining solvent on a dry basis. The remaining solvent amount is calculated by {(x−y)/y}×100, when x is a weight of a sample taken from the film, and y is a weight of the dried sample.

In the clip tenter 14, the both side edges of the film 20 are held by the plurality of clips moved by a movement of an endless chain. The film 20 is dried while being transported through the clip tenter 14. During the transportation, a width of opposing clips is increased so as to increase a tension applied to the film 20 in the widthwise direction to stretch the film 20. Thereby, the molecules in the film 20 are oriented so that a desired retardation value is imparted to the film 20.

After the film 20 is released from the clip tenter 14, the both side edges of the film 20 are cut off by the edge slitting device 43. Thereafter, the film 20 is transported through the drying chamber 15 and the cooling chamber 16, and then wound up by a winding shaft 51 in the winding chamber 17. The both side edges cut off by the edge slitting device 43 are crushed by the crusher 44 and reused as chips for dope preparation.

The film 20 wound by the winding shaft 51 preferably has a length of at least 100 min the lengthwise direction (the casting direction). The width of the film 20 is preferably not less than 600 mm, and more preferably not less than 1400 mm and not more than 2500 mm. The present invention is also effective when the film width is 2500 mm or more. The present invention is also applicable for producing a thin film having a thickness of not less than 20 μm and not more than 80 μm.

In FIG. 2, extraneous matters, or deposits are adhered to the surface 32b of the casting drum 32 due to continuous casting after the wet film 38 is peeled off. The extraneous matters or the deposits are precipitated from the casting film 33 while the casting film 33 is cooled by the casting drum 32, and contain fatty acid ester or the like as a main component. The shifting section adjusts the position and the blast direction of the nozzle 66 to satisfy the desired blast distance L1 and the blast angle θ1. The drum cleaning device 65 blasts the gas mixture from the blast orifice 66a onto the surface 32b of the casting drum 32 after the wet film 38 is peeled off therefrom and before the next casting film 33 is formed thereon.

When the gas mixture is blasted from the drum cleaning device 65, the dry ice particles contained in the gas mixture collide with the extraneous matters on the surface 32b of the casting film 32. The extraneous matters are crushed and removed by collision energy. Further, the dry ice particles are melted by the collision energy between the dry ice particles and the extraneous matters and that between the dry ice particles and the surface 32b of the casting drum 32. Thus, liquid carbon dioxide generated on the surface 32b of the casting drum 32 dissolves the extraneous matters. In addition, it is also possible to remove the extraneous matters on the surface 32b by evaporation of the liquid carbon dioxide containing the extraneous matters. The extraneous matters on the surface 32b are easily removed by the synergy of the above.

By using the above configured drum cleaning device 65 capable of blasting the gas mixture, it becomes possible to easily remove the extraneous matters adhered to the casting drum 32 without traces of the cleaning solvent. By disposing the drum cleaning device 65 close to the surface 32b of the casting drum 32 between the decompression chamber 36 and the peel roller 34, it becomes possible to clean the surface 32b of the casting drum 32 without suspending the film production line 10. Since the dry ice particles are blasted onto the casting drum 32, it is possible to prevent the damages on the surface 32b of the casting drum 32. The above method of blasting the dry ice particles is applicable to a cleaning device for cleaning the surface 32b of the casting drum 32 under explosion-proof conditions.

The removal effect of the extraneous matters by the blast of the gas mixture depends on a particle diameter of the dry ice, the blast pressure of the gas mixture, the blast angle θ1 between the blast direction of the gas mixture and the surface 32b of the casting drum 32, the blast distance L1 between the surface 32b of the casting drum 32 and the blast orifice 66a. In the present invention, the particle diameter is preferably not less than 5 μm and not more than 20 μm. The blast pressure of the gas mixture is preferably not less than 600 kPa and not more than 4000 kPa, more preferably not less than 1000 kPa and not more than 2500kPa. In the case the blast pressure exceeds 4000 kPa, the nozzle may be clogged with the dry ice particles, which is not preferable. The blast angle θ1 between the blast direction of the gas mixture and the surface 32b of the casting drum 32 is preferably not less than 45° and not more than 135°, more preferably not less than 70° and not more than 110°, and most preferably not less than 85° and not more than 95°. The blast distance L1 between the blast orifice 66a of the nozzle 66 and the surface 32b of the casting drum 32 is preferably not less than 0.1 mm and not more than 15 mm, more preferably not less than 0.1 mm and not more than 10 mm, and most preferably not less than 0.1 mm and not more than 2 mm. The blast time for blasting the gas mixture onto the surface 32b of the casting drum 32, which depends on the above conditions, is preferably not less than 0.001 second and not more than 5 seconds, more preferably not less than 0.01 second and not more than 5 seconds, and most preferably not less than 1 second and not more than 5 second.

The blast distance L1 is a distance between the blast orifice 66a and a collision point on the surface 32b. The collision point is a point on which the gas mixture blasted from the blast orifice 66a hits. The blast time is a time for blasting the gas mixture onto a predetermined area of the surface 32b.

In the above embodiment, the extraneous matters adhered to the surface of the casting drum 32 contain the fatty acid ester as the main component. However, the main component is not limited to the above. The main component can be fatty acid, fatty acid metal salt, or the like. It is also possible to remove extraneous matters which can be crushed by the blast of the dry ice particles, or dissolved into liquid carbon dioxide and evaporated together with the liquid carbon dioxide.

The fatty acid ester can be generated by, for instance, a reaction of a fatty acid contained in a polymer and alcohol contained in a solvent, or a reaction of an additive added to the dope in the dope preparation process and alcohol contained in the solvent. The fatty salt metal salt can be generated by a reaction of the fatty acid contained in the dope and an ion of a metal atom. In that case, the metal ion is Mg²⁺, Ca²⁺, or the like. The fatty acid, alcohol, and metal atom are not limited to those contained in the dope.

In the above embodiment, the gas mixture containing the dry ice particles and air is used. Instead of air, it is also possible to use nitrogen gas or inert gas.

In the present invention, instead of the casting drum 32, a belt bridged across the rollers can also be used.

In the above embodiment, in the film production line 10, the extraneous matters are removed from the surface 32b of the casting drum 32 in the film production line 10, that is, the extraneous matters are removed online. It is also possible to remove the extraneous matters off line, that is, the same removal treatment as above is applied to the surface 32b of the casting drum 32 after the casting drum 32 is detached from the film production line 10.

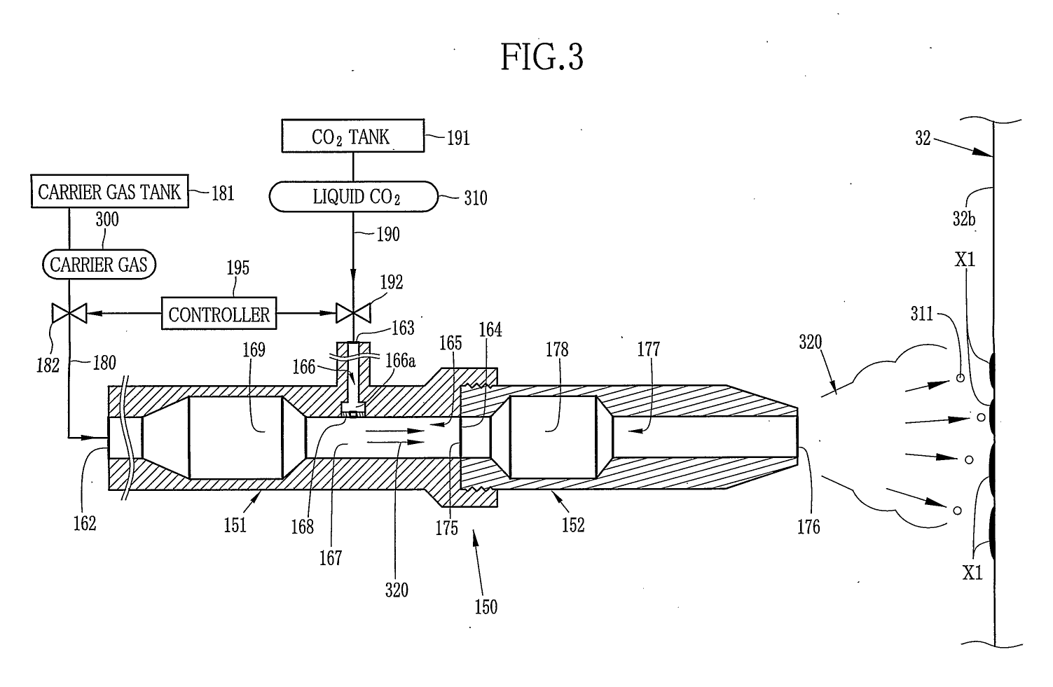

In the above embodiment, the dry ice particles generated by the dry ice blasting device 69 is mixed with air to generate the gas mixture (the cleaning gas). However, the present invention is not limited to the above. It is also possible to generate the gas mixture with the dry ice particles generated by blasting liquid carbon dioxide. Next, referring to FIG. 3, an embodiment of the drum cleaning device using liquid carbon dioxide is described. In this embodiment, a drum cleaning device 150 includes a first nozzle 151 and a second nozzle 152.

The first nozzle 151 has a carrier gas inlet 162 from which a carrier gas 300 is introduced, a carbon dioxide inlet 163 from which liquid carbon dioxide 310 is introduced, a cleaning gas orifice 164 from which a cleaning gas 320 is blasted, a carrier gas channel 165 which connects the carrier gag inlet 162 and the cleaning gas orifice 164, and a carbon dioxide channel 166 which connects the carbon dioxide inlet 163 and the carrier gas channel 165. The carrier gas channel 165 has a particle generation section 167 which generates the cleaning gas 320 containing the dry ice particles 311 from the carrier gas 300 and the liquid carbon dioxide 310 supplied from the carbon dioxide channel 166. The carbon dioxide channel 166 has an orifice 168 at an outlet 166a. At an upstream from the particle generation section 167, the carrier gas channel 165 is provided with a rectifying pocket 169 having a larger cross section than the carrier gas channel 165.

The second nozzle 152 has a cleaning gas inlet 175 from which the cleaning gas 320 from the cleaning gas orifice 164 is introduced, a cleaning gas orifice 176 from which the cleaning gas 320 is blasted, and a cleaning gas channel 177 which connects the carrier gas inlet 175 and the cleaning gas orifice 176. The carrier gas channel 177 is provided with a rectifying pocket 178 having a larger cross section than carrier gas channel 177.

The second nozzle 152 is coupled to the first nozzle 151 such that the cleaning gas orifice 164 and the cleaning gas inlet 175 are connected. The drum cleaning device 150 is disposed in the casting chamber 12 (see FIG. 1) such that the distance L1 between the surface 32b of the casting drum 32 and the cleaning gas orifice 176, and the blasting angle θ1 satisfy the desired values.

Through a pipe 180, the carrier gas inlet 162 is connected to a carrier gas tank 181 which supplies the carrier gas 300. The pipe 180 is provided with a throttle valve 182 which adjusts the flow rate of the carrier gas 300. Through a pipe 190, the carbon dioxide inlet 163 is connected to a carbon dioxide tank 191 which supplies liquid carbon dioxide 310. The pipe 190 is provided with a throttle valve 192 which adjusts the flow rate of the liquid carbon dioxide 310.

The throttle valves 182 and 192 are controlled by a controller 195. Under the control of the controller 195, the throttle valves 182 and 192 are opened at desired degrees of opening. By adjusting the degrees of opening, the blast pressure of the cleaning gas 320, the particle diameter of the dry ice particles 311, a mixing ratio of the carrier gas 300 and liquid carbon dioxide 310 can be adjusted.

For instance, air can be used as the carrier gas 300. The carrier gas tank 181 can also store the carrier gas 300 compressed at a desired pressure. It is preferable to use the carbon dioxide of high purity. Conditions inside the carbon dioxide tank 191 and the pipe 190 should be kept such that the liquid carbon dioxide 310 maintains the liquid state from the carbon dioxide tank 191 to the particle generation section 167.

Next, an operation of the drum cleaning device 150 is described. Under the control of the controller 195, the throttle valves 182 and 192 are adjusted at desired degrees of opening. The carrier gas 300 is introduced from the carrier gas tank 181 to the carrier gas inlet 162 through the pipe 180, and then sent to the particle generation section 167 of the carrier gas channel 165 at a flow rate of Q1 (m³/mm·min). The liquid carbon dioxide 310 is introduced from the carbon dioxide tank 191 to the carbon dioxide inlet 163 through the pipe 190 and then sent to the carbon dioxide channel 166 at a mass flow rate of Q2 (kg/mm·min). The liquid carbon dioxide 310 sent to the carbon dioxide channel 166 is sent to the particle generation section 167 through the orifice 168. The liquid carbon dioxide 310 sent to the particle generation section 167 changes its phase into carbon dioxide gas and dry ice particles. With the flow of the carrier gas 300, the carbon dioxide gas and the dry ice particles collide with deposits X1 on the surface 32b, and thus the deposits X1 are removed from the surface 32b.

The deposits X1 are removed by the following actions (1) to (3), and by synergistic effects caused by the combinations thereof. (1) By the collision between the dry ice particles and the deposits X1, kinetic energy of the blasted dry ice particles crushes the deposits X1 adhered to the surface 32b. (2) By the collision between the dry ice particles and the deposits X1, dry ice particles become liquid carbon dioxide, and the deposits X1 are dissolved into the liquid carbon dioxide. (3) Volume expansion of the liquid carbon dioxide and the dry ice particles caused by the vaporization thereof blows the deposits X1 off from the surface 32b. The deposits X1 crushed and removed from the surface 32b by the effects caused by the collision with the dry ice particles are circulated with the atmosphere gas. Therefore, thickness unevenness, failure, and the like caused by the deposits X1 and residues thereof are prevented. Even if there are deposits X1 remaining on the surface 32b, the amount is extremely small, which does not lead to a failure.

(Mixing Ratio)

It is preferable that flow rates Q1 and Q2 in the cleaning gas 320 satisfy one of the following mathematical expressions (1) to (3).

0.0025≦Q2≦0.025 (kg/mm·min) on condition that 0.0075<Q1<0.025 (m³/mm·min) (1)

On condition that Q1 satisfies the above range (1), it is more preferable that Q2 is not less than 0.007 (kg/mm·min) and not more than 0.01 (kg/mm·min). It is most preferable that Q2 is approximately 0.0083 (kg/mm·min).

In the case Q1 is not more than 0.0075 (m³/mm·min), the deposits X1 cannot be sufficiently removed from the surface 32b, which is not preferable. When Q2 exceeds 0.025 (kg/mm·min), the carrier gas channels 165 and 177 of the drum cleaning device 150 are clogged with the dry ice particles 311 contained in the cleaning gas 320. As a result, the surface 32b cannot be cleaned sufficiently, which is not preferable.

0.0016≦Q2≦0.034 (kg/mm·min) on condition that 0.025≦Q1<0.05 (m³/mm·min) (2)

On condition that the Q1 satisfies the above range (2), it is more preferable that Q2 is not less than 0.0025 (kg/mm·min) and not more than 0.034 (kg/mm·min). It is most preferable that Q2 is not less than 0.0125 (kg/mm·min) and not more than 0.034 (kg/mm·min).

In the case Q2 is less than 0.0016 (kg/mm·min) on condition that 0.025≦Q1<0.05 (m³/mm·min), the deposits X1 cannot be sufficiently removed from the surface 32b, which is not preferable. In the case Q2 exceeds 0.034 (kg/mm·min), the carrier gas channels 165 and 177 of the drum cleaning device 150 are clogged with the dry ice particles 311. As a result, the surface 32b cannot be cleaned sufficiently, which is not preferable.

0.00083≦Q2≦0.042 (kg/mm·min) on condition that 0.05≦Q1<0.1 (m³/mm·min) (3)

On condition that Q1 satisfies the above range (3), it is more preferable that Q2 is not less than 0.0016 (kg/mm·min) and not more than 0.042 (kg/mm·min). It is most preferable that Q2 is not less than 0.0125 (kg/mm·min) and not more than 0.042 (kg/mm·min).

In the case that Q2 is less than 0.00083 (kg/mm·min) on condition that 0.05≦Q1<0.1 (m³/mm·min), the deposits X1 cannot be sufficiently removed from the surface 32b, which is not preferable. In the case Q2 exceeds 0.042 (kg/mm·min), the carrier gas channels 165 and 177 of the drum cleaning device 150 are clogged with the dry ice particles 311. As a result, the surface 32b cannot be cleaned sufficiently, which is not preferable. In the case Q1 is not less than 0.1 (m³/mm·min), surface defects may be formed on the surface 32b due to collision with the dry ice particles 311 contained in the cleaning gas 320, which is not preferable.

In the above embodiment, the drum cleaning device 150 having the first and second nozzles 151 and 152 are used. However, the present invention is not limited to the above. It is also possible to use the drum cleaning device only having the first nozzle 151. In that case, the flow rate Q2 preferably satisfies 0.00166≦Q2≦0.0025 (kg/mm·min) on condition that 0.05≦Q1<0.1 (m³/mm·min). In the case the flow rate Q1 is 0.1 (m³/mm·min) or more, the surface defects may be formed on the surface 32b due to collision with the dry ice particles 311 contained in the cleaning gas 320, which is not preferable. In the case the flow rate Q1 is less than 0.05 (m³/mm·min), the deposits X1 cannot be sufficiently removed from the surface 32b, which is not preferable. In the case the flow rate Q2 exceeds 0.0025 (kg/mm·min), the carrier gas channels 165 and 177 of the drum cleaning device 150 are clogged with the dry ice particles 311. As a result, the surface 32b cannot be cleaned sufficiently, which is not preferable. In the case the flow rate Q2 is less than 0.00166 (kg/mm·min), the deposits X1 cannot be sufficiently removed from the surface 32b, which is not preferable.

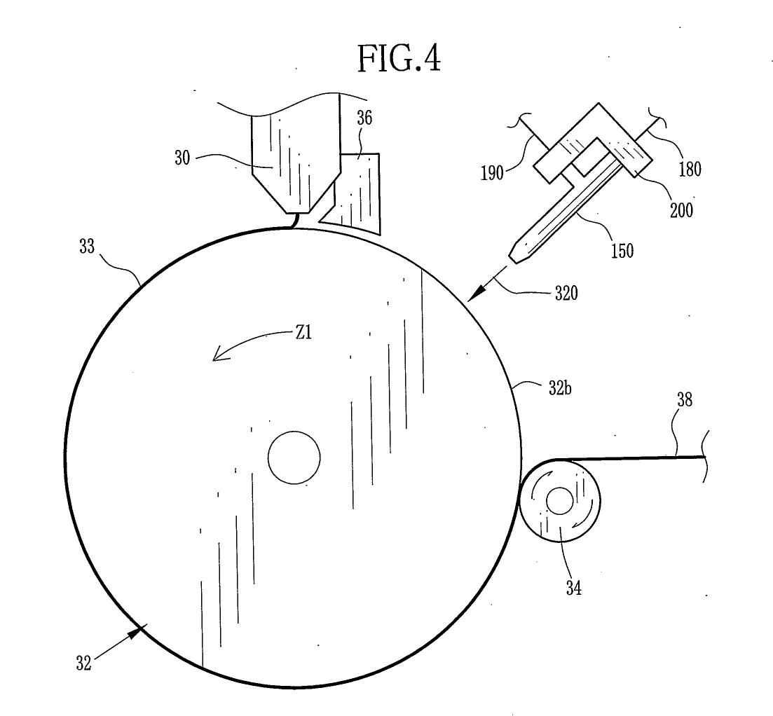

The present invention is not limited to the above embodiments. Configurations shown in FIGS. 4 to 7 are also possible.

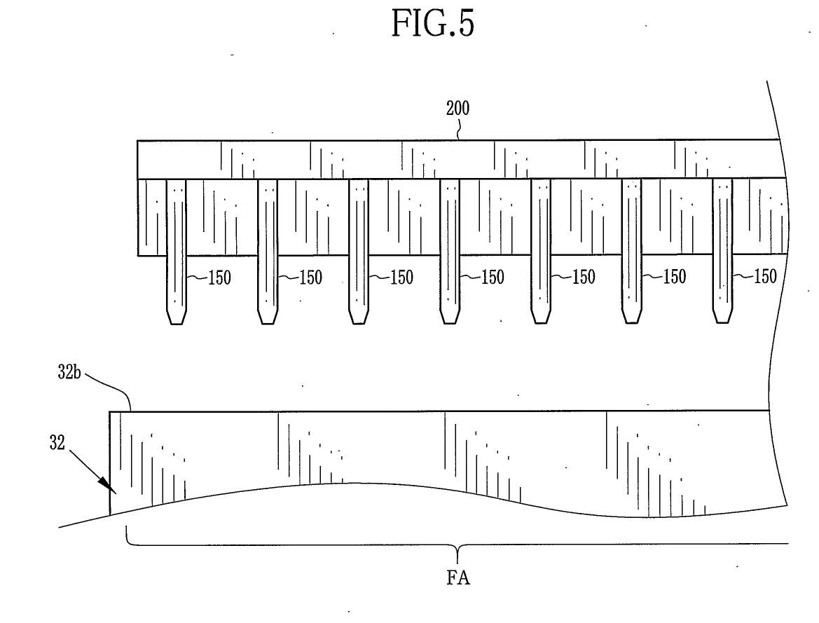

As shown in FIGS. 4 and 5, plural drum cleaning devices 150 are provided to a nozzle head 200 so as to cover a casting film forming area FA in the width direction of the casting drum 32. An arrangement pitch between the drum cleaning devices 150 is set such that the blast areas of the cleaning gas 320 from the adjacent drum cleaning devices 150 partly overlap with each other. The carrier gas 300 and the liquid carbon dioxide 310 are supplied to the nozzle head 200 through the pipes 180 and 190. Then, the carrier gas 300 and the liquid carbon dioxide 310 are respectively distributed and supplied to the carrier gas inlet 162 and the carbon dioxide inlet 163 of each drum cleaning device 150 at approximately constant flow rates through a manifold formed in the nozzle head 200. The casting film forming area FA is an area on the surface 32b in which the casting film 33 can be formed.

The dope 21 is cast onto the surface 32b of the casting drum 32 rotated around the shaft 32a to form the casting film 33 on the surface 32b. The peel roller 34 peels off the casting film 33. The peeled casting film 33 is referred to as the wet film 38. The drum cleaning device 150 provided in the nozzle head 200 blasts the cleaning gas 320 onto the surface 32b after the casting film 33 is peeled off and before the next casting film 33 is formed. Thus, it becomes possible to blast the cleaning gas 320 over the entire casting film forming area FA on the surface 32b.

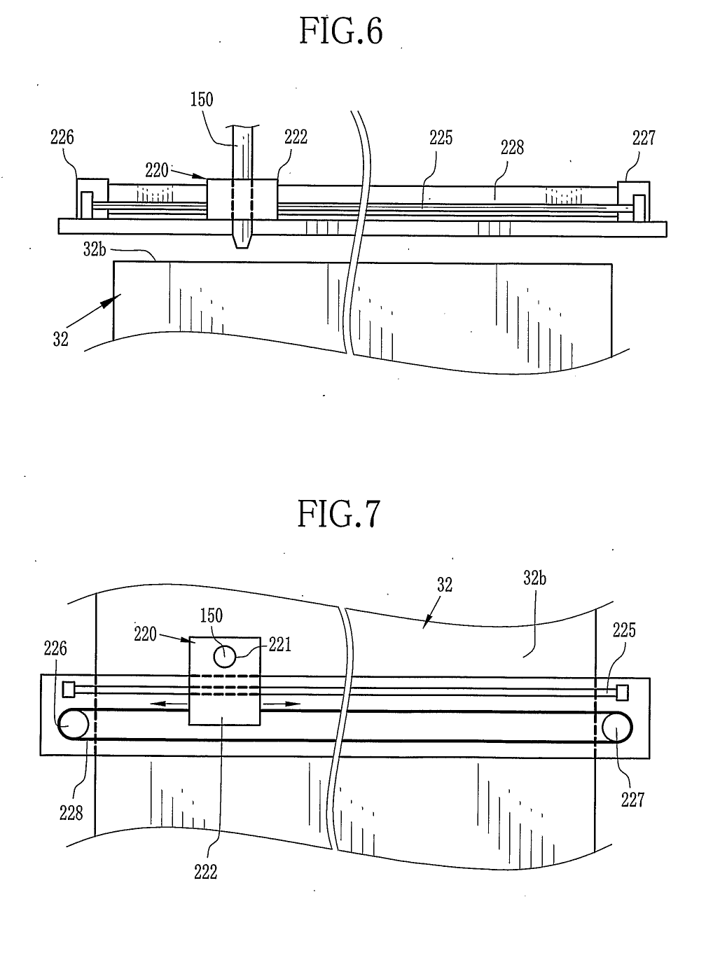

As shown in FIGS. 6 and 7, a head section 220 has a through hole 221 and a carriage 222. The drum cleaning device 150 is attached through the through hole 221. The drum cleaning device 150 is fixed to the head section 220 with a fixing means (not shown). A distance between the drum cleaning device 150 and the surface 32b is adjusted at a desired value by the through hole 221 and the fixing means. The carriage 222 is inserted into a guide shaft 225 extending in the width direction of the casting drum 32. A part of the carriage 222 is connected to a belt bridged across a pair of pulleys 226 and 227. The pair of pulleys is connected to a pulley control section (not shown).

The dope 21 is cast onto the surface 32b of the casting drum 32 rotated around the shaft 32a to form the casting film 33 on the surface 32b. The peel roller 34 peels off the casting film 33. The peeled casting film 33 is referred to as the wet film 38. The drum cleaning device 150 blasts the cleaning gas 320 onto the surface 32b after the casting film 33 is peeled off and before the next casting film 33 is formed. The head section 220 to which the drum cleaning section 150 is attached sifts the drum cleaning device 150 in the width direction according to the control of the pulley control section. Thus, it becomes possible to thoroughly blast the cleaning gas 320 over the entire casting film forming area FA on the surface 32b. Further, it becomes possible to clean the surface 32b in the width direction approximately simultaneously by increasing a shifting speed of the drum cleaning device 150. On the contrary, by reducing the shifting speed of the drum cleaning device 150, it becomes possible to clean the surface 32b in an approximately spiral direction. Accordingly, the entire casting film forming area FA can be cleaned after plural rotations of the casting drum 32. In this case, the shifting speed of the drum cleaning device 150 and the rotation speed of the casting drum 32 can be synchronized.

In the above embodiment, one drum cleaning device 150 is fixed per head section 220. However, the present invention is not limited to the above. It is also possible to fix plural drum cleaning devices 150 per head section 220, or to provide plural head sections 220 to the belt 228. With the use of the above configurations, the entire casting film forming area FA can be cleaned more quickly as the number of the drum cleaning devices 150 increases.

Hereinafter, the material for preparing the dope 21 of the present invention is described.

In this embodiment, cellulose acylate is used as a polymer. In particular, cellulose triacetate (TAC) is especially preferable. In the cellulose acylate to be used in the present invention, a degree of substitution of hydroxyl group preferably satisfies all of the following formulae (1)-(3).

2.5≦A+B≦3.0 (1)

0≦A≦3.0 (2)

0≦B≦2.99 (3)

In these formulae (1) to (3), A is the degree of substitution of the hydrogen atom of the hydroxyl group for the acetyl group, and B is a degree of substitution of the hydroxyl group for the acyl group with 3-22 carbon atoms. Preferably, at least 90 wt. % of the TAC particles have a diameter from 0.1 mm to 4 mm. However, the polymer used in the present invention is not limited to the cellulose acylate.

The cellulose is constructed of glucose units making β-1,4 combination, and each glucose unit has a free hydroxyl group at second, third and sixth positions. Cellulose acylate is a polymer in which a part of or the entire of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl group at the same position are substituted, the degree of substitution at this position is 1.

When the degrees of substitution of the acyl groups for the hydroxyl group at the second, third or sixth positions are respectively described as DS2, DS3 and DS6, the total degree of substitution of the acyl groups for the hydroxyl group at the second, third and sixth positions (namely DS2+DS3+DS6) is preferably in the range of 2.00 to 3.00, particularly in the range of 2.22 to 2.90, and especially in the range of 2.40 to 2.88. Further, DS6/(DS2+DS3+DS6) is preferably at least 0.28, and more preferably 0.30, and especially preferably in the range of 0.31 to 0.34.

One or more sorts of acyl group may be contained in the cellulose acylate of the present invention. When two or more sorts of the acyl groups are used, it is preferable that one of the sorts is acetyl group. If the total degree of substitution of the acetyl groups for the hydroxyl group and that of acyl groups other than the acetyl group for the hydroxyl group at the second, third or sixth positions are respectively described as USA and DSB, the value DSA+DSB is preferably in the range of 2.22 to 2.90, and especially preferably in the range of 2.40 to 2.88.

Further, the DSB is preferable to be at least 0.30, and especially at least 0.7. Further, in DSB, the percentage of the substituent for the hydroxyl group at the sixth position is preferably at least 20%, more preferably at least 25%, especially at least 30% and most especially at least 33%. Further, the degree of the acyl groups at sixth position is at least 0.75, particularly at least 0.80, and especially preferable to be 0.85. By cellulose acylate satisfying the above conditions, a solution (or dope) having excellent dissolubility can be prepared. Especially when non-chlorine type organic solvent is used, the adequate dope with a low viscosity and a high filterability can be prepared.

The cellulose acylate can be obtained from cotton linter or pulp.

The acyl group having at least 2 carbon atoms may be aliphatic group or aryl group, and is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtyl carbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. In this invention, the dope refers to a polymer solution or a polymer dispersion obtained by dissolving or dispersing a polymer in a solvent.

The preferable solvent compounds are the halogenated hydrocarbons having 1 to 7 carbon atoms, and dichloromethane is especially preferable. In view of physical properties such as a solubility of TAC, a peelability of a casting film from a support, a mechanical strength, optical properties of the film and the like, it is preferable to mix at least one sort of the alcohol having 1 to 5 carbon atoms into the halogenated hydrocarbons. The content of the alcohols is preferably in the range of 2 wt. % to 25 wt. %, and especially in the range of 5 wt. % to 20 wt. % of total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ether with 4 to 12 carbon atoms, ketone with 3 to 12 carbon atoms, ester with 3 to 12 carbon atoms, alcohol with 1 to 12 carbon atoms, or a mixture of them. For instance, a solvent mixture of methyl acetate, acetone, ethanol, and n-butanol can be used. The ether, ketone, ester, and alcohol may have a cyclic structure. A compound having two or more functional groups of the ether, ketone, ester, and alcohol (that is, —O—, —CO—, —COO—, and —OH—) can be used as the solvent.

The cellulose acylate is described in detail in paragraphs [0140]-[0195] of the Japanese Patent Laid-Open Publication No. 2005-104148, and the description can be applied to the present invention. Further, details of the solvent of cellulose acylate and additives, such as plasticizers, deterioration inhibitor, ultraviolet absorbing agent (UV agent), optical anisotropy controlling agent, retardation controlling agent, dye, matting agent, peeling agent and peeling promotion agent, are disclosed in paragraphs [0196] to [0516] of Japanese Patent Laid-Open Publication No. 2005-104148.

The solution casting method of the present invention may be a co-casting method in which two or more sorts of the dopes are simultaneously cast, or a sequentially casting method in which two or more sorts of the dopes are sequentially cast. Further, the co-casting method and the sequentially casting method are utilized in combination. When the co-casting is performed, the casting die with the feed block or a multi-manifold type casting die can be used. In the multi-layer film produced by the co-casting method, the thickness of at least one of the layers on the support side and on its opposite side is preferably in a range of 0.5% to 30% to the total thickness of the multi-layer film. Furthermore, in the co-casting method, when the dope is cast from a die slit onto the support, it is preferable that the lower viscosity dopes may entirely cover over the higher viscosity dope. Furthermore, in the co-casing method, when the dope is cast onto the support, it is preferable that the inner dope is covered with dopes whose alcohol contents are higher than the inner dope.

Note that paragraphs from [06171] to [08891] of Japanese Patent Laid-Open Publication No. 2005-104148 describe in detail the structures of the casting die, the decompression chamber and the support, the co-casting, the peeling, the stretching, the drying condition in each process, a handling method, curling, a winding method after the correction of planarity, a recovering method of the solvent, and a recovering method of film, which can be applied to the present invention.

### EXAMPLE 1

### Film Production

In the film production line 10, the dope 21 was cast onto the cylindrical casting drum 32 with the diameter of 1000 mm to form the casting film 33. The dope 21 was cast to obtain the film with the dry thickness of 80 μm. The chromium plating and a mirror finish processing were performed to the surface 32b of the casting drum 32. After the casting film 33 obtained the self supporting property, the casting film 33 was peeled off by the peel roller 34 to obtain the wet film 38. The wet film 38 was dried in the pin tenter 13 and the clip tenter 14 until the remaining solvent amount was reduced to a certain value to obtain the film 20. The extraneous matters or the deposits remaining on the surface 32b of the casting drum 32 were checked by the visual inspection. An IR (infrared) spectrophotometer, a GCMS (Gas Chromatograph Mass Spectrometer), and an NMR (Nuclear Magnetic Resonance) spectrometer were used to verify that the main component of the deposits was fatty acid ester. After the deposits were detected on the surface 32b of the casting drum 32, the casting was suspended, and the surface 32b was cleaned as described in the following. The result of the cleaning was checked by the visual inspection.

[Drum Cleaning]

The drum cleaning device 65 (product name: Snocle, produced by Link Star Japan, Co., Ltd.) was used. A nozzle with an orifice made of Teflon (registered trademark) was used as the nozzle 66. The blast angle θ1 between the blast direction of the gas mixture and the surface 32b of the casting drum 32 was 85°. The blast distance L1 between the blast orifice 66a of the nozzle 66 and the surface 32b of the casting drum 32 was 15 mm. The blast pressure of the gas mixture was 896.35 kPa. The insulation temperature of the casting drum 32 was approximately −10° C. Under the above conditions, the gas mixture was blasted onto the surface 32b of the casting drum 32 for 0.001 second, 0.01 second, 0.2 seconds, 1 second, and 5 seconds. When the gas mixture was blasted for 0.001 second, a part of the deposits on the surface 32b of the casting drum 32 were removed. However, traces of the cleaning solvent were left thereon. When the gas mixture was blasted for 0.1 second and 0.2 seconds, the deposits were removed from the entire surface 32b of the casting drum 32. When the gas mixture was blasted for 1 second, the deposits were sufficiently removed. When the gas mixture was blasted for 5 seconds, the effect of removing the deposits was maximized. After the blasting of the dry ice particles, the surface 32b of the casting drum 32 was observed by an optical microscope, and there was no damage caused by the blast of the gas mixture.

### EXAMPLE 2

The film production line 10, the drum cleaning device 65, and the nozzle 66 were the same as in the example 1. In the example 1, the blast time was fixed at 0.01 second. The blast angle θ1 between the surface 32b of the casting drum 32 and the nozzle 66 was set at 45°, 60°, 70°, 85°, and 90° and the surface 32b was cleaned at each setting. Other conditions were the same as in the example 1. When θ1 was set at 45° and 60°, a part of the deposits were removed. When θ1 was set at 70° and 85°, the deposits were removed from the entire surface 32b. When θ1 was approximately 90°, the removal effect of the deposits was maximized. After the blast of the dry ice particles, the surface 32b of the casting drum 32 was observed with the optical microscope, and there was no damage caused by the blast of the gas mixture.

### EXAMPLE 3

The film production line 10, the drum cleaning device 65, and the nozzle 66 were the same as in the example 1. In the example 1, the blast time was fixed to 0.01 second. The blast distance L1 was set at 0.1 mm, 2 mm, 5 mm, 10 mm, and 15 mm, and the surface 32b was cleaned at each setting. Other conditions were the same as in the example 1. When the blast distance L1 was 15 mm, a part of the deposits were removed. When the blast distance L1 was 5 mm and 10 mm, the deposits were removed from the entire surface 32b. When the blast distance L1 was 2 mm, the deposits were sufficiently removed. When the blast distance L1 was 0.1 mm, the removal effect of the deposits was maximized. After the blast of the dry ice particles, the surface 32b of the casting drum 32 was observed with the optical microscope, and there was no damage caused by the blast of the gas mixture.

### EXAMPLE 4

The film production line 10, the drum cleaning device 65, and the nozzle 66 were the same as in the example 1. In the example 1, the blast time was fixed to 0.01 second. The blast pressure of the gas mixture was set at 689.5 kPa, 896.5 kPa, 1379 kPa, 2068 kPa, and 3447.5 kPa, and the surface 32b was cleaned at each setting. When the blast pressure was 689.5 kPa, a part of the deposits were removed. When the blast pressure was 896.5 kPa and 1379 kPa, the deposits were removed from the entire surface 32b. When the blast pressure was 2068 kPa, the deposits were sufficiently removed. When the blast pressure was 3447.5 kPa, the removal effect of the deposits was maximized. However, the blast orifice 66a of the nozzle 66 was clogged with the dry ice particles. After the blast of the dry ice particles, the surface 32b of the casting drum 32 was observed with the optical microscope, and no damage is caused by the blast of the gas mixture.

### EXAMPLE 5

The film production line 10, the drum cleaning device 65, and the nozzle 66 were the same as in the example 1. In the example 1, the blast time was fixed to 0.01 second. The temperature of the surface 32b of the casting drum 32 was set at −10° C., 0° C., and 15° C., and the surface 32b was cleaned at each setting. At each temperature, the deposits of the surface 32b of the casting drum 32 were removed. The removal effect, of the deposits increased as the temperature of the surface 32b increased. The removal effect was maximized when the temperature of the surface 32b was set at 15° C. After the blast of the dry ice particles, the surface 32b of the basting drum 32 was observed with the optical microscope, and there was no damage caused by the blast of the gas mixture.

### COMPARATIVE EXAMPLE 1

A film production line 10 was the same as in the example 1. An ultraviolet lamp (a low pressure mercury lamp, model No.: SLC-500ATK, produced by GS Yuasa Lighting, Ltd.) was used instead of the drum cleaning device 65. A blast distance between the ultraviolet lamp and surface 32b of the casting drum 32 was 50 mm. An insulation temperature T of the surface 32b of the casting drum 32 was −10° C. Under the above conditions, the ultraviolet rays were irradiated onto the surface 32b for cleaning. As a result, the irradiation time took 60 minutes to sufficiently remove the deposits.

As described above, according to the present invention, the deposits adhered to the surface 32b were easily removed by blasting the gas mixture containing the dry ice onto the surface 32b of the casting drum 32 after the casting film 33 was peeled off. Thus, it was no longer necessary to stop the film production for removing the deposits. Accordingly, the production efficiency in the solution casting method was improved.

### EXAMPLE 6

The fatty acid ester put on a test piece was removed by using the drum cleaning device 150.

A stainless steel plate made of SUS 316 was used as the test piece. The surface of the test piece was polished to make the surface roughness not more than 0.01 μm.

Fatty acid ester was put on the surface of the test piece. A thermocouple was provided on the surface of the test piece, and the test piece was placed on the temperature controller. The surface temperature of the test piece was kept at not less than −10° C. and not more than 0° C. with the use of the thermocouple and the temperature controller.

Snocle produced by Link Star Japan, Co., Ltd was used as the drum cleaning device 150. The drum cleaning device 150 was installed such that the blast distance L1 between the orifice and the surface of the test piece was 15 mm, and the blast angle θ1 was approximately 90°. At the room temperature and in the atmosphere, the cleaning gas 320 was blasted onto the area of the test piece on which fatty acid ester was put. The controller 195 adjusted the throttle valves 182 and 192 to make the average particle diameter of the dry ice particles 311 contained in the cleaning gas 320 to be not less than 5 μm and not more than 20 μm.

1. Measurement of Cleaning Time

The fatty acid ester was removed while the flow rates Q1 and Q2 were adjusted by the controller 195. The flow rate Q1 took the following values: 0.0075 (m³/mm·min), 0.0125 (m³/mm·min), 0.025 (m³/mm·min), 0.0375 (m³/mm·min), 0.05 (m³/mm·min), 0.0625 (m³/mm·min), 0.0875 (m³/mm·min), and 0.1 (m³/mm·min). The flow rate Q2 took the following values: 0.417 (g/mm·min), 0.833 (g/m·min), 1.667 (g/mm·min), 2.5 (g/mm·min), 8.333 (g/mm·min), 12.5 (g/mm·min), 25 (g/mm·min), 33.333 (g/mm·min), 41.667 (g/mm·min), and 47.917 (g/mm·min). A time CT1 between the start of blasting the cleaning gas and the removal of the fatty acid ester was measured. Whether the fatty acid ester was removed or not was visually inspected. The time CT1 was evaluated as follows.

A: CT1 was not more than 0.1 second.

B: CT1 was more than 0.1 second and not more than 1 second.

C: CT1 was more than 1 second and not more than 20 seconds.

F: CT1 was more than 20 seconds or cleaning was not possible.

2. Evaluation of Surface Conditions

Damages on the surface of the test piece caused by the blasting of the cleaning gas were observed with the optical microscope after the blasting. The following evaluations were made.

A: No pinholes (less than 30 μm) were formed by the blasting on the surface 32b.

F: Pin holes of less than 30 μm were formed by the blasting on the surface 32b.

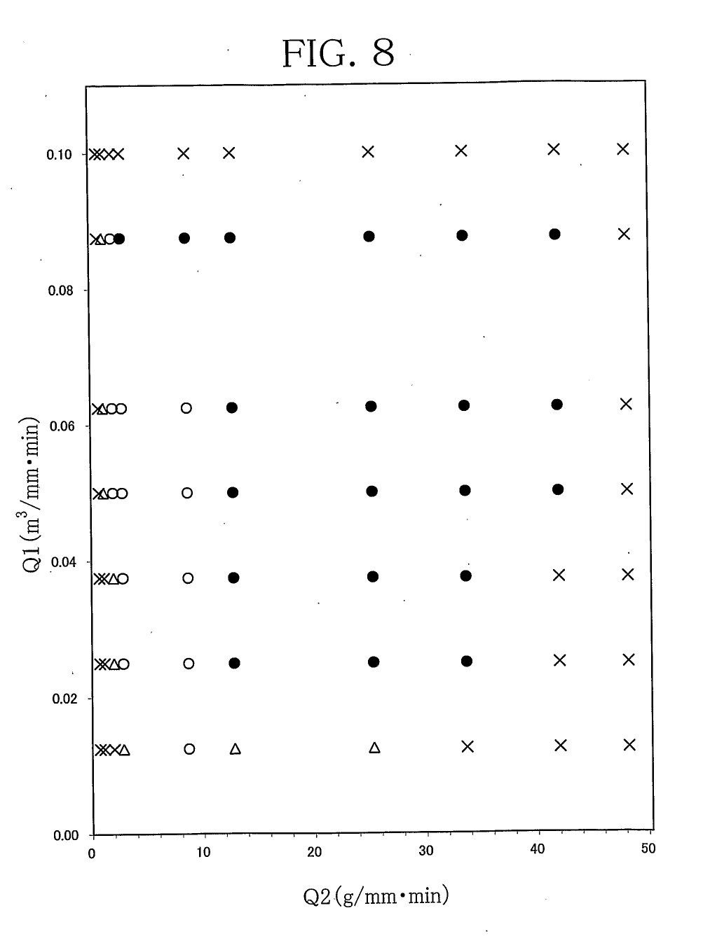

Tables 1-1, 1-2, 2-1, and 2-2 show the combinations of the flow rates Q1 and Q2, together with the values of A1, the time CT1, and the results of the surface conditions. A1 is a value of Q1/Q2. FIG. 8 shows correlations between the flow rates Q1 and Q2, and the results. Tables 3-1 and 3-2 show the results of the surface conditions.

TABLE 1-1

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0075 | | | 0.0125 | | |
| Q2 | 0.000417 | 17.986 | F | B | 29.976 | F | B |
| (kg/mm · | 0.000833 | 9.004 | F | B | 15.006 | F | B |
| min) | 0.001667 | 4.499 | F | B | 7.499 | F | B |
| | 0.002500 | 3.000 | F | B | 5.000 | C | B |
| | 0.008333 | 0.900 | F | B | 1.500 | B | B |
| | 0.012500 | 0.600 | F | B | 1.000 | C | B |
| | 0.025000 | 0.300 | F | B | 0.500 | C | B |
| | 0.033333 | 0.225 | F | B | 0.375 | F | B |
| | 0.041667 | 0.180 | F | B | 0.300 | F | B |
| | 0.047917 | 0.157 | F | B | 0.261 | F | B |

TABLE 1-2

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0250 | | | 0.0375 | | |
| Q2 | 0.000417 | 59.952 | F | B | 89.928 | F | B |
| (kg/mm · | 0.000833 | 30.012 | F | B | 45.018 | F | B |
| min) | 0.001667 | 14.997 | C | B | 22.496 | C | B |
| | 0.002500 | 10.000 | B | B | 15.000 | B | B |
| | 0.008333 | 3.000 | B | B | 4.500 | B | B |
| | 0.012500 | 2.000 | A | B | 3.000 | A | B |
| | 0.025000 | 1.000 | A | B | 1.500 | A | B |
| | 0.033333 | 0.750 | A | B | 1.125 | A | B |
| | 0.041667 | 0.600 | F | B | 0.900 | F | B |
| | 0.047917 | 0.522 | F | B | 0.783 | F | B |

TABLE 2-1

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0500 | | | 0.0625 | | |
| Q2 | 0.000417 | 119.904 | F | B | 149.880 | F | B |
| (kg/mm · | 0.000833 | 60.024 | C | B | 75.030 | C | B |
| min) | 0.001667 | 29.994 | C | B | 37.493 | B | B |
| | 0.002500 | 20.000 | B | B | 25.000 | B | B |
| | 0.008333 | 6.000 | B | B | 7.500 | B | B |
| | 0.012500 | 4.000 | A | B | 5.000 | A | B |
| | 0.025000 | 2.000 | A | B | 2.500 | A | B |
| | 0.033333 | 1.500 | A | B | 1.875 | A | B |
| | 0.041667 | 1.200 | A | B | 1.500 | A | B |
| | 0.047917 | 1.043 | F | B | 1.304 | F | B |

TABLE 2-2

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0875 | | | 0.1000 | | |
| Q2 | 0.000417 | 209.832 | F | B | 239.808 | F | F |
| (kg/mm · | 0.000833 | 105.042 | C | B | 120.048 | C | F |
| min) | 0.001667 | 52.490 | B | B | 59.988 | B | F |
| | 0.002500 | 35.000 | A | B | 40.000 | A | F |
| | 0.008333 | 10.500 | A | B | 12.000 | A | F |
| | 0.012500 | 7.000 | A | B | 8.000 | A | F |
| | 0.025000 | 3.500 | A | B | 4.000 | A | F |
| | 0.033333 | 2.625 | A | B | 3.000 | A | F |
| | 0.041667 | 2.100 | A | B | 2.400 | A | F |
| | 0.047917 | 1.826 | F | B | 2.087 | F | F |

### EXAMPLE 7

Fatty acid ester was removed from the test piece in the same way as in the example 6 except that the drum cleaning device 150 from which the second nozzle 152 was detached was used.

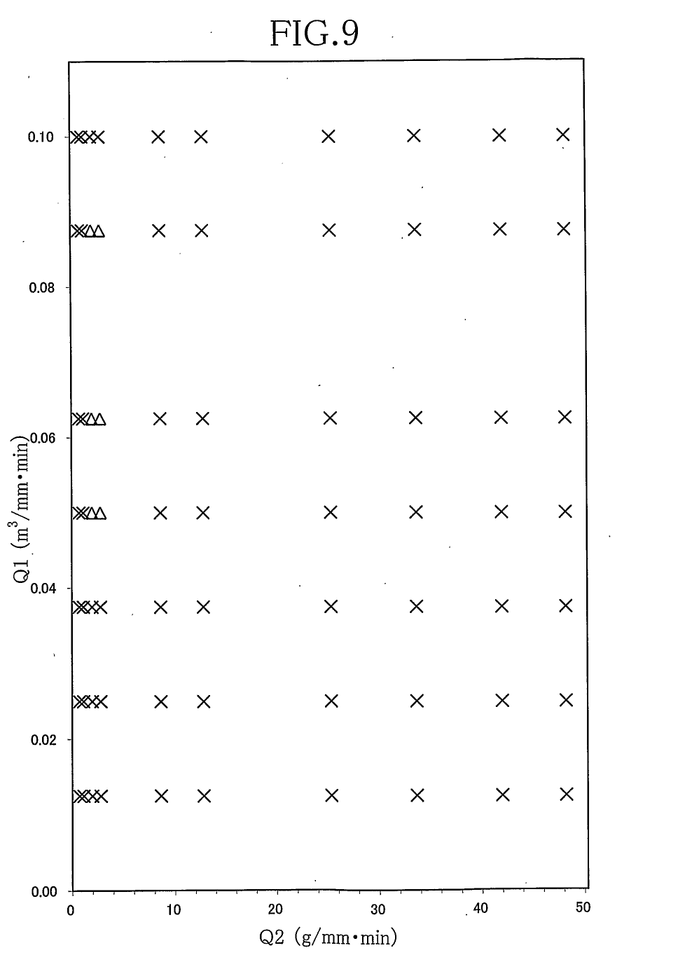

Tables 3-1, 3-2, 4-1 and 4-2 show the combinations of the flow rates Q1 and Q2 together with the values of A1, the time CT1, and the results of the surface conditions. FIG. 9 shows correlations between the flow rates Q1 and Q2, and the results.

TABLE 3-1

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0075 | | | 0.0125 | | |
| Q2 | 0.000417 | 17.986 | F | B | 29.976 | F | B |
| (kg/mm · | 0.000833 | 9.004 | F | B | 15.006 | F | B |
| min) | 0.001667 | 4.499 | F | B | 7.499 | F | B |
| | 0.002500 | 3.000 | F | B | 5.000 | F | B |
| | 0.008333 | 0.900 | F | B | 1.500 | F | B |
| | 0.012500 | 0.600 | F | B | 1.000 | F | B |
| | 0.025000 | 0.300 | F | B | 0.500 | F | B |
| | 0.033333 | 0.225 | F | B | 0.375 | F | B |
| | 0.041667 | 0.180 | F | B | 0.300 | F | B |
| | 0.047917 | 0.157 | F | B | 0.261 | F | B |

TABLE 3-2

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0250 | | | 0.0375 | | |
| Q2 | 0.000417 | 59.952 | F | B | 89.928 | F | B |
| (kg/mm · | 0.000833 | 30.012 | F | B | 45.018 | F | B |
| min) | 0.001667 | 14.997 | F | B | 22.496 | F | B |
| | 0.002500 | 10.000 | F | B | 15.000 | F | B |
| | 0.008333 | 3.000 | F | B | 4.500 | F | B |
| | 0.012500 | 2.000 | F | B | 3.000 | F | B |
| | 0.025000 | 1.000 | F | B | 1.500 | F | B |
| | 0.033333 | 0.750 | F | B | 1.125 | F | B |
| | 0.041667 | 0.600 | F | B | 0.900 | F | B |
| | 0.047917 | 0.522 | F | B | 0.783 | F | B |

TABLE 4-1

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0500 | | | 0.0625 | | |
| Q2 | 0.000417 | 119.904 | F | B | 149.880 | F | B |
| (kg/mm · | 0.000833 | 60.024 | F | B | 75.030 | F | B |
| min) | 0.001667 | 29.994 | C | B | 37.493 | C | B |
| | 0.002500 | 20.000 | C | B | 25.000 | C | B |
| | 0.008333 | 6.000 | F | B | 7.500 | F | B |
| | 0.012500 | 4.000 | F | B | 5.000 | F | B |
| | 0.025000 | 2.000 | F | B | 2.500 | F | B |
| | 0.033333 | 1.500 | F | B | 1.875 | F | B |
| | 0.041667 | 1.200 | F | B | 1.500 | F | B |
| | 0.047917 | 1.043 | F | B | 1.304 | F | B |

TABLE 4-2

| | | Q1 | | | | | |
|---|---|---|---|---|---|---|---|
| | | (m³/mm · min) | | | | | |
| | | A1 | results | | A1 | results | |
| | | (m³/kg) | 1 | 2 | (m³/kg) | 1 | 2 |
| | | 0.0875 | | | 0.1000 | | |
| Q2 | 0.000417 | 209.832 | F | B | 239.808 | F | F |
| (kg/mm · | 0.000833 | 105.042 | F | B | 120.048 | F | F |
| min) | 0.001667 | 52.490 | C | B | 59.988 | C | F |
| | 0.002500 | 35.000 | C | B | 40.000 | C | F |
| | 0.008333 | 10.500 | F | B | 12.000 | F | F |
| | 0.012500 | 7.000 | F | B | 8.000 | F | F |
| | 0.025000 | 3.500 | F | B | 4.000 | F | F |
| | 0.033333 | 2.625 | F | B | 3.000 | F | F |
| | 0.041667 | 2.100 | F | B | 2.400 | F | F |
| | 0.047917 | 1.826 | F | B | 2.087 | F | F |

According to examples 6 and 7, in the drum cleaning method by which the cleaning gas was blasted, the deposits were effectively removed without causing the damages to the surface of the test piece by setting the ratio of the flow rate Q1 of the carrier gas and the flow rate Q2 of the liquid carbon dioxide in the above described range. Thus, the present invention facilitates the removal of the deposits without damaging the surface 32b. As a result, the production efficiency of the solution casting method is improved. The drum cleaning device 150 having both the first and second nozzles 151 and 152 has greater removal effect than the drum cleaning device 150 only having the first nozzle 151. This is due to the rectified flow formed by the second nozzle 152 which enables the orifice to blast the uniform gas mixture over the entire surface 32b. By using the second nozzle 152, the removal of the deposits adhered to the surface 32b is facilitated in the high-speed solution casting method (at the velocity of 50 m/min or more). Therefore, the effect of removing the deposits in the present invention is extremely superior to the conventional drum cleaning methods so that the surface 32b of the casting drum 32 is cleaned in a short time. As a result, present invention further improves the production efficiency of the solution casting method.

### INDUSTRIAL APPLICABILITY

The solute ion casting method and the deposit removing device of the present invention are applicable to the production of the films used as the photosensitive films and the optical functional films.

1. A solution casting method comprising the steps of:
casting a dope containing a polymer and a solvent onto a surface of a moving endless support to form a casting film on said surface;
peeling said casting film from said surface and drying said peeled casting film to form a film; and
blasting a cleaning gas containing particles onto said surface after said casting film being peeled off and before next casting film being formed.

2. A solution casting method according to claim 1, wherein said particles are dry ice particles.

3. A solution casting method according to claim 2, wherein said average particle diameter of said dry ice is not less than 5 μm and not more than 20 μm.

4. A solution casting method according to claim 1, wherein said cleaning gas is blasted onto said surface for a time not less than 0.001 second and not more than 5 seconds.

5. A solution casting method according to claim 1, wherein a blast angle between said surface and a blast direction of said cleaning gas is not less than 45° and not more than 135°.

6. A solution casting method according to claim 2, wherein said cleaning gas is blasted through a nozzle, and a carrier gas and liquid carbon dioxide are supplied to said nozzle, and said cleaning gas containing dry ice particles is generated by feeding said liquid carbon dioxide into a channel of said carrier gas inside said nozzle.

7. A solution casting method according to claim 6, wherein one of the following mathematical expressions is satisfied when Q1 (m³/mm·min) is a volume flow rate of said carrier gas, and Q2 (kg/mm·min) is a mass flow rate of said carbon dioxide:
0.0025≦Q2≦0.025 (kg/mm·min) on condition that 0.0075<Q1<0.025 (m³/mm·min) (1)
0.0016≦Q2≦0.034 (kg/mm·min) on condition that 0.025≦Q1<0.05 (m³/mm·min) (2)
0.00083≦Q2≦0.042 (kg/mm·min) on condition that 0.05≦Q1<0.1 (m³/mm·min) (3)

8. A solution casting method according to claim 6, said nozzle further including:
a carrier gas inlet for introducing said carrier gas,
a carbon dioxide inlet for introducing said liquid carbon dioxide;
a cleaning gas orifice for blasting said cleaning gas;
a carrier gas channel for connecting said carrier gas inlet and said cleaning gas orifice;
a carbon dioxide channel for connecting said carbon dioxide inlet and said carrier gas channel;
a particle generation section provided in said carrier gas channel and including an outlet of said carbon dioxide channel, said particle generation section generating said dry ice particles by feeding said liquid carbon dioxide to said carrier gas channel.

9. A solution casting method according to claim 8, wherein an outlet of said carbon dioxide channel is provided with an orifice.

10. A solution casting method according to claim 8, wherein a rectifying pocket having a larger cross section than said carrier gas channel is provided in said carrier gas channel for rectifying said carrier gas.

11. A solution casting method according to claim 8, wherein a distance between said cleaning gas orifice and said surface is not less than 0.1 mm and not more than 15 mm.

12. A solution casting method according to claim 1, wherein a blast pressure of said cleaning gas is not less than 600 kPa and not more than 4000 kPa.

13. A solution casting method according to claim 1, wherein said support is a casting drum.

14. A solution casting method according to claim 1, wherein deposits on said surface contain at least one of fatty acid, fatty acid ester, and fatty acid metal salt.

15. A solution casting method according to claim 1, wherein said polymer contains cellulose acylate.

16. A solution casting method according to claim 15, wherein said cellulose acylate is one of cellulose triacetate cellulose acetate, propionate, and cellulose acetate butyrate.

17. A deposit removing device for removing deposits from a surface of a moving endless support of a solution casting apparatus, said solution casting apparatus casting a dope containing a polymer and a solvent onto said surface to form a casting film and peeling said casting film from said surface and drying said peeled casting film to form a film, said deposit removing device comprising:
a nozzle for blasting a cleaning gas containing particles on said surface, said nozzle provided close to an area of said surface between a position from which said casting film being peeled and a position onto which said dope being cast to form a next casting film.

18. A deposit removing device according to claim 17, wherein said particles contain dry ice.

19. A deposit removing device according to claim 18, wherein said average particle diameter of said dry ice is not less than 5 μm and not more than 20 μm.

20. A deposit removing device according to claim 17, wherein said cleaning gas is blasted onto said surface for a time not less than 0.001 second and not more than 5 seconds.

21. A deposit removing device according to claim 17, wherein a blast angle between a blast direction of said cleaning gas and said surface is not less than 45° and not more than 135°.

22. A deposit removing device according to claim 18, wherein a carrier gas and liquid carbon dioxide are supplied to said nozzle, and said cleaning gas containing dry ice particles is generated by feeding said liquid carbon dioxide into a channel of said carrier gas inside said nozzle.

23. A deposit removing device according to claim 22, wherein one of the following mathematical expressions is satisfied when Q1 (m³/mm·min) is a volume flow of said carrier gas, and Q2 (kg/mm·min) is a mass flow of said carbon dioxide:
0.0025≦Q2≦0.025 (kg/mm·min) on condition that 0.0075<Q1<0.025 (m³/mm·min) (4)
0.0016≦Q2≦0.034 (kg/mm·min) on condition that 0.025≦Q1<0.05 (m³/mm·min) (5)
0.00083≦Q2≦0.042 (kg/mm·min) on condition that 0.05≦Q1<0.1 (m³/mm·min) (6)

24. A deposit removing device according to claim 17, said nozzle further including;
a carrier gas inlet for introducing said carrier gas,
a carbon dioxide inlet for introducing said liquid carbon dioxide;
a cleaning gas orifice for blasting said cleaning gas;
a carrier gas channel for connecting said carrier gas inlet and said cleaning gas orifice;
a carbon dioxide channel for connecting said carbon dioxide inlet and said carrier gas channel; and
a particle generation section provided in said carrier gas channel and including an outlet of said carbon dioxide channel, said particle generation section generating said dry ice particles by feeding said liquid carbon dioxide to said carrier gas channel.

25. A deposit removing device according to claim 24, wherein an outlet of said carbon dioxide channel is provided with an orifice.

26. A deposit removing device according to claim 24, wherein a rectifying pocket having a larger cross section than said carrier gas channel is provided in said carrier gas channel for rectifying said carrier gas.

27. A deposit removing device according to claim 17, wherein a distance between said cleaning gas orifice and said surface is not less than 0.1 mm and not more than 15 mm.

28. A deposit removing device according to claim 17, wherein a blast pressure of said cleaning gas is not less than 600 kPa and not more than 4000 kPa.

29. A deposit removing device according to claim 24, wherein said deposit removing device includes a plurality of said nozzles disposed in a width direction of said support.

30. A deposit removing device according to claim 17, wherein said support is a casting drum.

31. A deposit removing device according to claim 17, wherein said deposits contain at least one of fatty acid, fatty acid ester, and fatty acid metal salt.

32. A deposit removing device according to claim 17, wherein said polymer contains cellulose acylate.

33. A deposit removing device according to claim 32, wherein said cellulose acylate is one of cellulose triacetate, cellulose acetate, propionate, and cellulose acetate butyrate.
